(19) United States
(12) Patent Application Publication
(10) Pub. No.: US 2022/0157188 A1
(43) Pub. Date: May 19, 2022

(54) LEARNING PROBLEM RECOMMENDATION SYSTEM FOR RECOMMENDING EVALUABLE PROBLEMS THROUGH UNIFICATION OF FORMS OF SCORE PROBABILITY DISTRIBUTION AND METHOD OF OPERATING THE SAME

(71) Applicant: RIIID INC., Seoul (KR)

(72) Inventor: Hyun Bin LOH, Seoul (KR)

(21) Appl. No.: 17/523,898

(22) Filed: Nov. 10, 2021

(30) Foreign Application Priority Data
Nov. 13, 2020 (KR) 10-2020-0151516

(51) Int. Cl. G09B 7/00

(52) U.S. Cl. CPC G09B 7/00

(57) ABSTRACT

Provided is a learning problem recommendation system for recommending problems through unification of forms of a score probability distribution. In some embodiments, the system generates a first problem candidate list by combining a preset number of problems, predicts a probability distribution of expected scores that a user will receive after the user solves the problems, determines a second problem candidate list on the basis of a result of comparing an extracted value extracted from a graph of the probability distribution of the expected scores to a preset reference value, predicts a learning effect that the user will have after the user solves the problems, determines a third problem candidate list on the basis of the learning effect, and determines a recommended problem list to recommend by filtering the first problem candidate list, the second problem candidate list, and the third problem candidate list according to a predetermined order.

### CROSS-REFERENCE TO RELATED APPLICATION

This application claims priority to and the benefit of Korean Patent Application No. 2020-0151516, filed on Nov. 13, 2020, in the Korean Intellectual Property Office, the disclosure of which is incorporated herein by reference in its entirety.

### BACKGROUND

### 1. Field

The present disclosure relates to a learning problem recommendation system capable of providing individually customized problems to users to maximize a learning effect and, at the same time, evaluating abilities of the users even without a separate test, and a method of operating the same. More specifically, the present disclosure relates to a technique in which forms of a probability distribution of expected scores for a problem list provided to each of users are unified and thus the fairness of evaluation of abilities of the users is increased using results of problem solving and the problem solving is effectively used to improve the abilities of the users.

### 2. Description of Related Art

Recently, as the Internet and electronic devices have been actively used in various fields, educational environments are also changing rapidly. In particular, with the development of various educational media, learners can select and use a wider range of learning methods. Among the learning methods, an educational service through the Internet has become a major teaching and learning method because of advantages of overcoming time and space constraints and enabling low-cost education.

In response to such a trend, customized educational services, which were not possible in offline education due to limited human and material resources, are also becoming diverse. For example, by providing segmentalized educational content according to the individuality and ability of a learner by utilizing artificial intelligence, the educational content is provided according to the individual competency of the learner, breaking away from the uniform education method in the past.

In this case, the educational content to be recommended to a user may be classified into problems for the user's learning and problems for the user's ability evaluation. In a formative learning system, when problems are recommended, problems that are optimized for user's learning are provided rather than problems for user's ability evaluation. That is, the problem recommendation method in the formative learning system may be referred to as a problem recommendation method in which the entire process thereof is focused on “what makes learning best.”

In the formative learning system, in order for problems with higher learning efficiency to be determined as recommended problems, “evaluation” of a student's ability needs to be made automatically even through solving problems only for the student's “learning.” That is, when the student has taken an action for the best learning, the evaluation of the student's ability should be done automatically. However, the problem recommendation method in the formative learning system is focused only on the “learning,” and thus there is a problem in that the objectivity and fairness of “evaluation” through problem recommendation cannot be ensured.

### SUMMARY

Aspects of the present disclosure are to address at least the above-mentioned problems and/or disadvantages and to provide at least the advantages described below.

Accordingly, an aspect of the present disclosure is directed to providing a learning problem recommendation system in which, by unifying forms of a probability distribution of expected scores for a problem list to be provided to each of users according to a predetermined criterion and then determining problems to be recommended to each user, recommended problems that are able to ensure objectivity and fairness are determined when evaluating each user's ability, and a method of operating the same.

Another aspect of the present disclosure is also directed to providing a learning problem recommendation system in which, by unifying forms of a probability distribution of expected scores to make improvement of the score after learning relative to current ability of the user be proportional to the effort that the user has put into the learning, recommended problems that are able to inspire the user's learning motivation and improve the fairness of learning are determined, and a method of operating the same.

Additional aspects will be set forth in part in the description which follows and, in part, will be apparent from the description, or may be learned by practice of the presented embodiments.

In accordance with an aspect of the present disclosure, there is provided a learning problem recommendation system for recommending problems through unification of forms of a score probability distribution, the learning problem recommendation system includes a problem candidate list generation unit configured to generate a first problem candidate list to be recommended to a user by combining a preset number of problems among problems stored in a problem database, a score distribution determination unit configured to predict a probability distribution of expected scores that the user will receive after the user solves the problems included in the first problem candidate list and to determine a second problem candidate list on the basis of a result of comparing an extracted value extracted from a graph of the probability distribution of the expected scores to a preset reference value, and a learning effect determination unit configured to predict a learning effect that the user will have after the user solves the problems included in the first problem candidate list and to determine a third problem candidate list on the basis of the predicted learning effect. Here, a recommended problem list to be recommended to the user is determined by filtering the first problem candidate list, the second problem candidate list, and the third problem candidate list according to a predetermined order.

According to another aspect of the present invention, there is provided a method of operating a learning problem recommendation system for recommending problems through unification of forms of a score probability distribution, the method includes generating a first problem candidate list to be recommended to a user by combining a preset number of problems among problems stored in a problem database, predicting a probability distribution of expected scores that the user will receive after the user solves the problems included in the first problem candidate list and determining a second problem candidate list on the basis of a result of comparing an extracted value extracted from a graph of the probability distribution of the expected scores to a preset reference value, and predicting a learning effect that the user will have after the user solves the problems included in the first problem candidate list and determining a third problem candidate list on the basis of the learning effect. Here, a recommended problem list to be recommended to the user is determined by filtering the first problem candidate list, the second problem candidate list, and the third problem candidate list according to a predetermined order.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features and advantages of certain embodiments of the present disclosure will become more apparent form the following description taken in conjunction with the accompanying drawings, in which:

FIG. 1 is a diagram for describing a configuration of a learning problem recommendation system according to an embodiment of the present disclosure;

FIG. 2 shows graphs for describing problems that occur in a case in which recommended problems are determined without considering a score distribution of each user in a conventional formative learning system;

FIG. 3 shows graphs for describing a case in which forms of a probability distribution of expected scores of each user are unified based on an average score and standard deviation of each user according to an embodiment of the present disclosure;

FIG. 4 shows graphs for describing a case in which forms of a probability distribution of expected scores of each user are unified based on a minimum score and standard deviation of each user according to another embodiment of the present disclosure;

FIG. 5 is a flowchart for describing a method of operating a learning problem recommendation system according to an embodiment of the present disclosure;

FIG. 6 is a flowchart for describing a method of operating a learning problem recommendation system according to another embodiment of the present disclosure; and

FIG. 7 is a hardware configuration diagram of a computing device that may be implemented as a learning problem recommendation apparatus in a learning problem recommendation system according to some embodiments of the present disclosure.

### DETAILED DESCRIPTION

Hereinafter, embodiments of the present disclosure will be described in detail with reference to the accompanying drawings, the same or similar components are denoted by the same reference numerals regardless of reference numbers, and thus the description thereof will not be repeated.

A suffix “module,” “unit,” “part,” or “portion” of an element used herein is assigned or incorporated for convenience of specification description and the suffix itself does not have a distinguished meaning or function.

In descriptions of the embodiments of the present disclosure, it should be understood that when an element is referred to as being “connected” or “coupled” to another element, it can be directly connected or coupled to another element or intervening elements may be present. In contrast, when an element is referred to as being “directly connected” or “directly coupled” to another element, there are no intervening elements present.

Further, in descriptions of the embodiments of the present disclosure, when detailed descriptions of related known configurations or functions are deemed to unnecessarily obscure the gist of the present disclosure, the detailed descriptions will be omitted. Further, the accompanying drawings are only examples to facilitate overall understanding of the embodiments of the present disclosure and the technological scope disclosed in this specification is not limited to the accompanying drawings. It should be understood that the present disclosure covers all modifications, equivalents, and alternatives falling within the spirit and scope of the present invention.

It will be understood that, although the terms “first,” “second,” etc. may be used herein to describe various elements, these elements should not be limited by these terms. These terms are only used to distinguish one element from another element.

As used herein, the singular forms “a” and “an” are intended to also include the plural forms, unless the context clearly indicates otherwise.

In this specification, it should be further understood that the terms “comprise,” “comprising,” “include,” and/or “including,” when used herein, specify the presence of stated features, integers, steps, operations, elements, parts, or combinations thereof, but do not preclude the presence or addition of one or more other features, integers, steps, operations, elements, parts, or combinations thereof.

The embodiments of the present disclosure disclosed in this specification and drawings are only examples to aid understanding of the present disclosure and the present disclosure is not limited thereto. It is clear to those skilled in the art that various modifications based on the technological scope of the present invention can be made in addition to the embodiments disclosed herein.

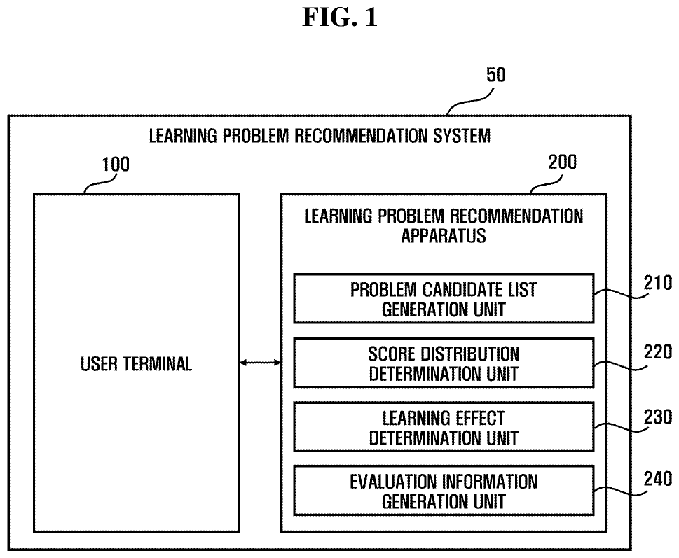

FIG. 1 is a diagram for describing a configuration of a learning problem recommendation system according to an embodiment of the present disclosure.

Referring to FIG. 1, a learning problem recommendation system 50 may include a user terminal 100 and a learning problem recommendation apparatus 200.

In a formative learning system, when problems are recommended, problems that are optimized for user's learning are provided rather than problems for user's ability evaluation. That is, the problem recommendation method in the formative learning system may be referred to as a problem recommendation method in which the entire process thereof is focused on “what makes learning best.”

In the formative learning system, in order for problems with higher learning efficiency to be determined as recommended problems, “evaluation” of student's ability needs to be made automatically even through solving problems only for the student's “learning.” That is, when the student has taken an action for the best learning, the evaluation of the student's ability should be done automatically. However, the problem recommendation method in the formative learning system is focused only on the “learning,” and thus there is a problem in that the objectivity and fairness of “evaluation” through problem recommendation cannot be ensured.

Specifically, in the formative learning system for recommending problems that maximize a learning effect, when users solve problems, their ability may be improved as much as the effort that the users put into learning. In this case, when a probability distribution of expected scores to be predicted is different for each user according to problem solving results, it can be said that the recommended problems lack objectivity and fairness as evaluation problems for evaluating abilities of the users.

In order to solve the above problem, the learning problem recommendation system 50 according to the embodiment of the present disclosure determines a problem candidate list to be provided to the user. In addition, a probability distribution of expected scores that the user will receive after the user solves problems included in the problem candidate list may be predicted, and a recommended problem list may be determined from the problem candidate list on the basis of the probability distribution. The recommended problem list may include one or more problems and, in some embodiments, the number of problems may vary.

As shown in FIG. 1, the learning problem recommendation system 50 may include the user terminal 100 and the learning problem recommendation apparatus 200.

The learning problem recommendation apparatus 200 communicates with the user terminal 100. The learning problem recommendation apparatus 200 may recommend problems to the user through the user terminal 100 and collect problem solving results, which are responses input by the user with respect to the recommended problems, from the user terminal 100. The collected problem solving results may be analyzed through artificial intelligence and may be used to provide individually customized recommended problems to the user.

Conventionally, when recommending learning problems, only problems that can maximize a learning effect of an individual user have been determined as recommended problems. However, such a method of determining recommended problems does not sufficiently consider the interaction between a plurality of users attending the same class. As a result, there is a problem in that the improvement of ability compared to the effort put into solving the problems is different for each student, which lowers the students' motivation to learn.

In particular, in the case of public education, there is a high need to level the learning efficiency of students for each piece of provided educational content. However, there is a phenomenon that, according to the problems provided to individual students, some students achieve great improvement of their scores even with little effort as compared to other students whereas some students achieve small improvement of their scores even with more effort as compared to other students. As a result, the students that achieve small score improvement lose their motivation to learn and fall behind.

The learning problem recommendation apparatus 200 according to the embodiment of the present disclosure may solve the above-described problems by determining the problems that can unify forms of the probability distribution of expected scores of each user as the recommended problems rather than by simply determining the problems that can maximize the user's learning effect as the recommended problems.

Further, in the case in which the evaluation of the user's ability is diagnosed according to problem solving results of the user (e.g., results with correct or incorrect answers to ten problems), when the form of the probability distribution of the expected scores is different for each user, diagnosis using the problem solving results has no fairness as a diagnosis.

Therefore, the learning problem recommendation apparatus 200 may unify the forms of the probability distribution and determine the recommended problems so that the forms of the probability distribution of the expected scores according to the problem solving results are similar. Accordingly, in the formative learning system, there is an effect in that the improvement of the user's ability may be maximized, and at the same time, the user's ability may be determined.

The learning problem recommendation apparatus 200 may include a problem candidate list generation unit 210, a score distribution determination unit 220, a learning effect determination unit 230, and an evaluation information generation unit 240.

The problem candidate list generation unit 210 generates a problem candidate list to be recommended to the user by combining a preset number of problems among problems stored in a problem database (not shown).

The score distribution determination unit 220 uses an artificial intelligence score model to predict a probability distribution of expected scores that the user will receive after the user solves the problems included in the problem candidate list. Then, extracted values extracted from a graph of the probability distribution of the expected scores are compared to a preset reference value.

The learning effect determination unit 230 predicts a learning effect of the user after the user solves the problems in the problem candidate list. Then, a recommended problem list to be recommended to the user is determined according to the predicted learning effect.

The evaluation information generation unit 240 generates evaluation information on the basis of results of solving the problems included in the recommended problem list. The evaluation information may be information expressing ability of the user as a numerical value or grade that can be compared to that of another user.

Hereinafter, each component of the learning problem recommendation apparatus 200 will be described in more detail.

The problem candidate list generation unit 210 may generate the problem candidate list by combining the preset number of problems among the problems stored in the problem database.

According to an embodiment, the score distribution determination unit 220 firstly filters the problem candidate list on the basis of the probability distribution. Thereafter, the learning effect determination unit 230 may secondarily filter the firstly filtered problem candidate list on the basis of the expected scores. More specifically, the score distribution determination unit 220 may firstly filter the problem candidate list so that the expected scores that are received after the user solves the problems in the problem candidate list have a probability distribution that meets a preset criterion. In addition, the learning effect determination unit 230 may determine the recommended problem list which has the highest expected score that it is expected to have after the user solves the problems of the firstly filtered problems in the problem candidate list as a final recommended problem list.

According to another embodiment, after the learning effect determination unit 230 firstly filters the problem candidate list according to the expected scores, the score distribution determination unit 220 may secondarily filter the firstly filtered problem candidate list according to the probability distribution.

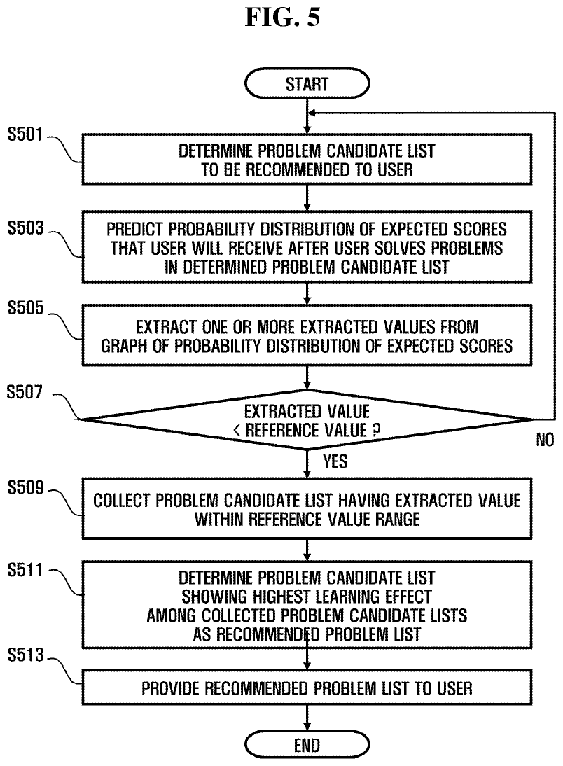

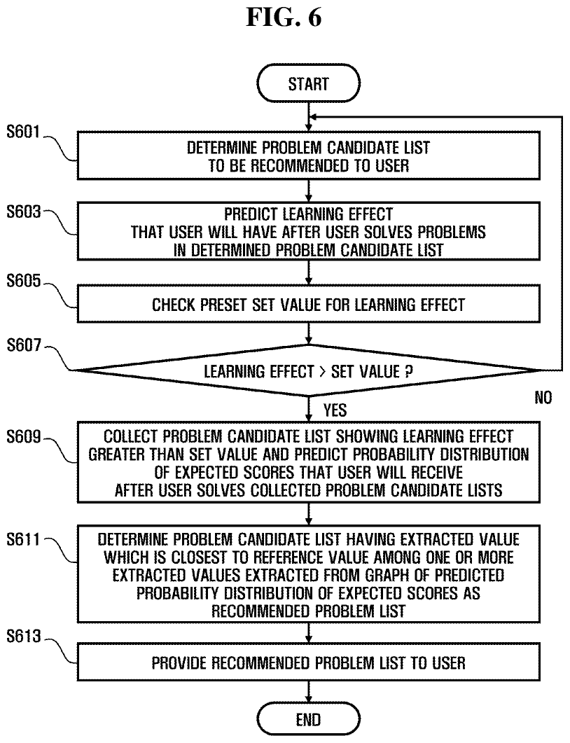

FIG. 5 is a flowchart for describing an example in which, among the score distribution determination unit 220 and the learning effect determination unit 230, the score distribution determination unit 220 filters first. FIG. 6 is a flowchart for describing an example in which, among the score distribution determination unit 220 and the learning effect determination unit 230, the learning effect determination unit 230 filters first. Descriptions of FIGS. 5 and 6 will be described below.

The score distribution determination unit 220 may predict the probability distribution of the expected scores that the user will receive after the user solves the problems in the problem candidate list. The prediction may be performed using a pre-trained artificial intelligence score model. Through the artificial intelligence score model, the probability that the user will get the correct answer for each problem of the problem candidate list may be predicted. Further, through the artificial intelligence score model, the score that the user will receive after the user solves the problem in the problem candidate list may be predicted.

The artificial intelligence score model may be trained in advance with problem solving data matched for each user. Here, the problem solving data includes the problems and the problem solving results, which are responses input by the user to the problems. One or more models among implementable artificial intelligence models such as a recurrent neural network (RNN), a long short-term memory (LSTM), a bidirectional LSTM, a transformer model, and the like may be used as the artificial intelligence score model.

The score distribution determination unit 220 may determine whether one or more extracted values extracted from the graph of the probability distribution of the expected scores are within a reference value range.

When it is determined that the extracted value is smaller than the reference value, the score distribution determination unit 220 may determine that the extracted value is suitable for problem recommendation. Conversely, when it is determined that the extracted value is greater than the reference value, the score distribution determination unit 220 may determine that the extracted value is not suitable for problem recommendation.

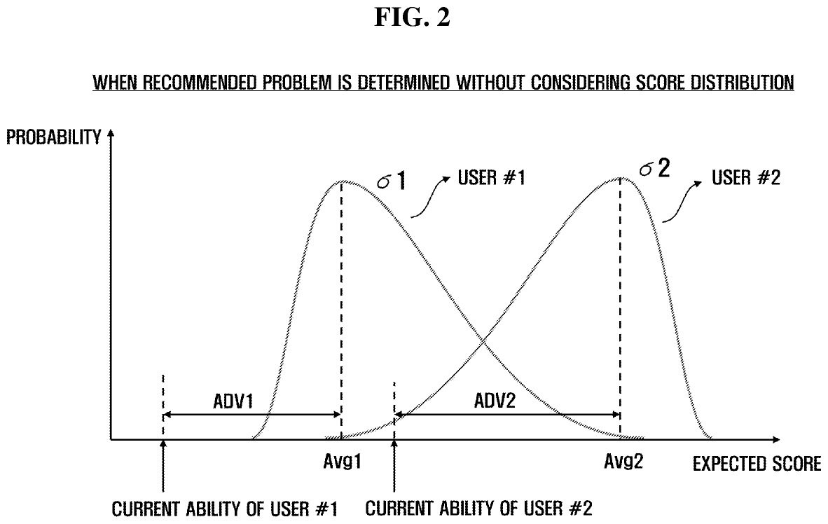

Graphs of FIGS. 2 to 4 show results of predicting a probability distribution of expected scores for different users (user #1 and user #2). Hereinafter, the operation of the score distribution determination unit 220 will be described in detail with reference to FIGS. 2 to 4.

FIG. 2 shows graphs for describing problems that occur in a case in which recommended problems are determined without considering a score distribution of each user in a conventional formative learning system.

Referring to FIG. 2, a left graph shows a probability distribution of expected scores to be obtained when a user #1 solves recommended problems. In addition, a right graph shows a probability distribution of expected scores to be obtained when a user #2 solves recommended problems.

In each graph, the score distribution of each user is not considered, but only factors that may maximize the expected scores that each user will obtain are considered, and thus it can be seen that forms of the score distributions of the users are different from each other.

Referring to FIG. 2, it is predicted that a probability that the user #1 will obtain a score of “Avg1” as an expected score that may be obtained after the user #1 solves the recommended problems is highest. Further, it is predicted that a standard deviation of the probability distribution of the expected scores is “σ1.” It is predicted that a probability that the user #2 will obtain a score of “Avg2” as an expected score that may be obtained after the user #2 solves the recommended problems is highest. Further, it is predicted that a standard deviation of the probability distribution of the expected scores is “σ2.”

This means that, in a current state before the user #1 solves the recommended problems, it is predicted that the user #1 will achieve score improvement by “Avg1,” that is, by “ADV1,” which is an expected score with the highest probability as compared to the current ability. This means that it is predicted that the user #2 will achieve score improvement by “Avg2,” that is, by “ADV2,” which is an expected score with the highest probability as compared to the current ability.

Referring to the probability distributions of the expected scores shown in FIG. 2, it can be seen that the user #2 achieves higher score improvement as compared to the user #1 (ADV1<ADV2) even when the user #1 and the user #2 perform learning with the same effort. As a result, the user #1 may lose his or her motivation to learn and fall behind more and more.

Further, since the probability distribution of the expected scores of the user #1 and the probability distribution of the expected scores of the user #2 are different, a problem in that the ability of the user #1 and the ability of the user #2 cannot be fairly evaluated only using the problem solving results of the recommended problems, which are determined without considering the probability distribution of the expected scores of each user, may occur.

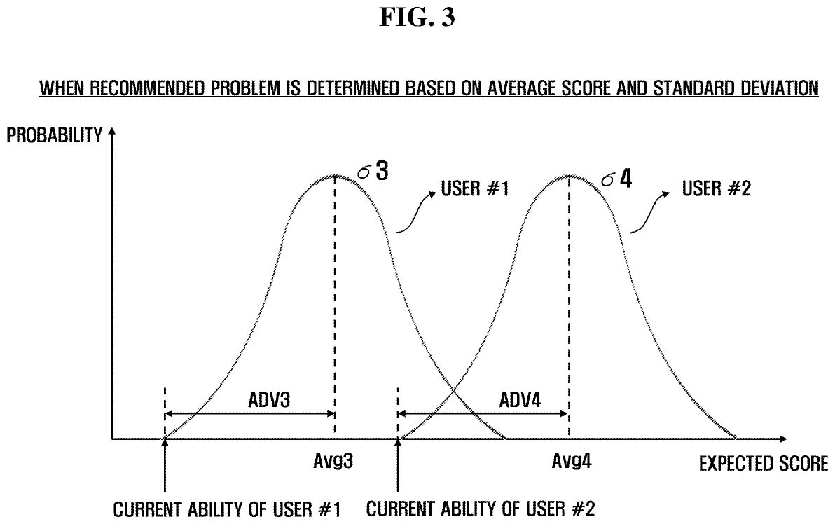

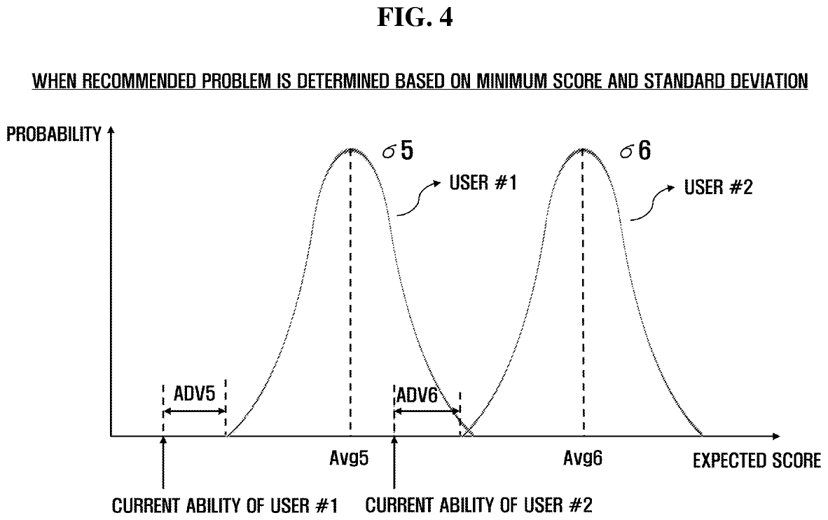

Therefore, as shown in graphs of FIGS. 3 and 4, by unifying forms of the probability distribution of the expected scores of different users according to a preset criterion and then by determining the recommended problems, the learning efficiency may be improved and the fairness in ability evaluation may be improved.

FIG. 3 shows graphs for describing a case in which forms of a probability distribution of expected scores of each user are unified based on an average score and standard deviation of each user according to an embodiment of the present disclosure.

Referring to FIG. 3, a left graph shows a probability distribution of expected scores to be obtained when a user #1 solves recommended problems. Further, a right graph shows a probability distribution of expected scores to be obtained when a user #2 solves recommended problems.

In each graph, factors that can make forms of the probability distribution of the expected scores of each user similar, such as an average score and a standard deviation, are considered together with factors that can maximize the expected scores of each user. As a result, it can be seen that the user #1 and the user #2 achieve the same average score improvement (ADV3=ADV4) and have the same standard deviation (σ3=σ4).

Referring to FIG. 3, it is predicted that a probability that the user #1 will obtain a score of “Avg3” as an expected score that may be obtained after the user #1 solves the recommended problems is highest. Further, it is predicted that a standard deviation of the probability distribution of the expected scores is “σ3.” It is predicted that a probability that the user #2 will obtain a score of “Avg4” as an expected score that may be obtained after the user #2 solves the recommended problems is highest. Further, it is predicted that a standard deviation of the probability distribution of the expected scores is “σ4.”

This means that, in the current state before the user #1 solves the recommended problems, it is predicted that the user #1 will achieve average score improvement by “ADV3” with the highest probability as compared to the current ability. Further, this means that it is predicted that the user #2 will achieve average score improvement by “ADV4” with the highest probability as compared to the current ability.

When compared to the graph of FIG. 2, in the graph of FIG. 3, not only the learning efficiency of each user but also the probability distribution of the expected scores of each user is considered. Therefore, when it is assumed that each of the user #1 and the user #2 solves the customized recommended problems with the same effort, the user #1 and the user #2 may achieve the same average ability improvement after solving the customized recommended problems (ADV3=ADV4). Further, the forms of the probability distributions of the expected scores of the user #1 and the user #2 are similar, and thus the customized recommended problems solved by the user #1 and the customized recommended problems solved by the user #2 may be used as information for determining each user's ability.

FIG. 4 shows graphs for describing a case in which forms of a probability distribution of expected scores of each user are unified based on a minimum score and standard deviation of each user according to another embodiment of the present disclosure.

Referring to FIG. 4, a left graph shows a probability distribution of expected scores to be obtained when a user #1 solves recommended problems. Further, a right graph shows a probability distribution of expected scores to be obtained when a user #2 solves recommended problems.

In each graph, factors that can make forms of the probability distribution of the expected scores of each user similar, such as a minimum score and a standard deviation, are considered together with factors that can maximize the expected scores of each user. As a result, it can be seen that the user #1 and the user #2 achieve the same minimum score improvement (ADV5=ADV6) and have the same standard deviation (σ5=σ6).

Referring to FIG. 4, it is predicted that a probability that the user #1 will obtain a score of “Avg5” as an expected score that may be obtained after the user #1 solves the recommended problems is highest. Further, it is predicted that a standard deviation of the probability distribution of the expected scores is “σ5.” It is predicted that a probability that the user #2 will obtain a score of “Avg6” as an expected score that may be obtained after the user #2 solves the recommended problems is highest. Further, it is predicted that a standard deviation of the probability distribution of the expected scores is “66.”

This means that, in the current state before the user #1 solves the recommended problems, it is predicted that the user #1 will achieve minimum score improvement by “ADV5” with the highest probability as compared to the current ability. Further, this means that it is predicted that the user #2 will achieve minimum score improvement by “ADV6” with the highest probability as compared to the current ability.

FIGS. 3 and 4 are only examples for making the forms of the probability distribution of the expected scores of each user similar. In some embodiments, various graph factors other than the average score, the minimum score, and the standard deviation may be used to make the forms of the probability distribution of the expected scores similar.

Referring to FIG. 1 again, the learning effect determination unit 230 predicts the learning effect of the user after the user solves the given problems in the problem candidate list. Based on the predicted learning effect, it is possible to determine the problem candidate list that will show the highest learning effect.

In order for the learning effect determination unit 230 to predict the learning effect of the user, a pre-trained artificial intelligence score model may be used. The artificial intelligence score model may predict the expected scores, which are scores that the user will receive after the user solves each problem in the problem candidate list. The learning effect of the user may be determined based on the expected scores. Further, the problem candidate list showing the highest score improvement may be the problem candidate list showing the highest learning effect.

However, in some embodiments, the learning effect may be determined using various artificial intelligence prediction results related to problem solving in addition to the expected scores. For example, at least one of a time required for solving the problems, a percentage of correct answers for problems, and a weak problem type may be used.

The problem candidate list may be firstly filtered by the score distribution determination unit 220 to have the probability distribution that meets a preset criterion. Thereafter, the firstly filtered problem candidate list may be secondarily filtered by the learning effect determination unit 230. That is, when the user completely solves the firstly filtered problems in the problem candidate list, the problem candidate list having the highest expected score that the user is expected to receive is filtered by the learning effect determination unit 230. After the problem candidate list is secondarily filtered, a final recommended problem list may be determined.

In some embodiments, after the learning effect determination unit 230 firstly filters the problem candidate list on the basis of the expected scores, the score distribution determination unit 220 may secondarily filter the firstly filtered problem candidate list on the basis of the probability distribution of the expected scores.

The recommended problem list determined according to the operation of the score distribution determination unit 220 and the learning effect determination unit 230 may be provided to the user through the user terminal 100. That is, the recommended problem list is transmitted to the user terminal 100 through a wired/wireless network (not shown). The transmitted recommended problem list may be displayed through an output unit, for example, a display, of the user terminal 100. Thereafter, the user may input a response with respect to each problem in the recommended problem list through an input unit, for example, a touch screen, of the user terminal 100. The problem solving results, which are responses input by the user, are transmitted to the learning problem recommendation apparatus 200 through the wired/wireless network. The learning problem recommendation apparatus 200 may match the recommended problem list, which is transmitted to the user terminal 100, and the problem solving results, which are received from the user terminal 100 to the corresponding user, and store a matching result.

The evaluation information generation unit 240 may generate evaluation information on the basis of the problem solving results of the user. Since the users solve the problems with a uniform probability distribution of expected scores, it is possible to evaluate abilities of the plurality of users even when the users solve different customized problem sets.

FIG. 5 is a flowchart for describing a method of operating the learning problem recommendation system 50 according to an embodiment of the present disclosure. FIG. 5 is a flowchart for describing an example in which a problem candidate list having a probability distribution of expected scores within a reference value range is determined and then a problem candidate list showing a highest learning effect is determined from the determined problem candidate list as a recommended problem list.

Referring to FIG. 5, in operation S501, the learning problem recommendation system 50 may determine a problem candidate list to be recommended to a user. The problem candidate list may include one or more problems.

The learning problem recommendation system 50 may generate the problem candidate list by combining a preset number of problems among problems stored in a problem database.

In operation S503, the learning problem recommendation system 50 may predict a probability distribution of expected scores that the user will receive after the user solves the problems in the problem candidate list determined in operation S501. A pre-trained artificial intelligence score model may be used for prediction.

The artificial intelligence score model may predict a probability that the user will get the correct answer for each problem in the problem candidate list for each problem. That is, the artificial intelligence score model calculates a probability that the user will get correct answers for all the problems in the problem candidate list. Further, based on the probability, it is possible to calculate the probability distribution of the expected scores to be received when the user solves all the problems in the problem candidate list.

In operation S505, the learning problem recommendation system 50 extracts one or more extracted values from a graph of the probability distribution of the expected scores. The extracted values may include one or more of various indicators that may represent the graph of the probability distribution of the expected scores. Examples of the indicators include an average score, a minimum score, a maximum score, a variance, and a standard deviation of the probability distribution of the expected scores.

In operation S507, the extracted value may be compared to a preset reference value.

As a result of the comparison in operation S507, when it is determined that the extracted value is smaller than the reference value, it is determined that the probability distribution of the expected scores has a desired form of the probability distribution and a corresponding problem candidate list may be firstly determined as a problem candidate list to be recommended to the user.

Conversely, as the result of the comparison in operation S507, when it is determined that the extracted value is greater than the reference value, it is determined that the probability distribution of the expected scores does not have the desired form of the probability distribution and the corresponding problem candidate list may be excluded from the recommendation. In this case, it is possible to return to operation S501 again to determine the problem candidate list, and operations S503 to S507 may be performed again.

In operation S507, when it is determined that the probability distribution of the expected scores has the desired form of the probability distribution, operation S509 may be performed. In operation S509, the learning problem recommendation system 50 may collect the problem candidate list having the extracted value within the reference value range.

Thereafter, in operation S511, the learning problem recommendation system 50 may determine the problem candidate list showing the highest learning effect among the collected problem candidate lists as a recommended problem list.

The pre-trained artificial intelligence score model may be used to predict the learning effect. The artificial intelligence score model may predict expected scores that the user will receive after the user solves each problem in the problem candidate list. The learning effect may be determined based on the predicted expected scores, and the problem candidate list showing the highest learning effect may be a problem candidate list composed of the problems with the highest score improvement.

However, in some embodiments, the learning effect may be determined using various artificial intelligence prediction results related to problem solving in addition to the expected scores. For example, at least one of a time required for solving the problems, a percentage of correct answers for problems, and a weak problem type may be used.

In operation S513, the learning problem recommendation system 50 may provide the recommended problem list to the user. Specifically, the learning problem recommendation system 50 may provide the recommended problem list to the user through the user terminal 100, and when the user inputs a response to each problem in the recommended problem list through the user terminal 100, the learning problem recommendation system 50 may receive results obtained by the user solving the problems from the user terminal 100.

The learning problem recommendation system 50 may generate evaluation information about the user on the basis of the results obtained by the user solving the problems. Since the users solve the problems with a uniform probability distribution of expected scores, it is possible to evaluate abilities of the plurality of users even when the users solve different customized problem sets.

FIG. 6 is a flowchart for describing a method of operating the learning problem recommendation system 50 according to another embodiment of the present disclosure. FIG. 6 is a flowchart for describing an example in which a problem candidate list having a learning effect greater than a preset value is determined and then a problem candidate list having a probability distribution of expected scores most similar to a reference value is determined from the determined problem candidate list as a recommended problem list.

Referring to FIG. 6, in operation S601, the learning problem recommendation system 50 may determine a problem candidate list to be recommended to a user. The problem candidate list may include one or more problems.

In operation S603, the learning problem recommendation system 50 may predict a learning effect that the user will have after the user solves the problems in the problem candidate list determined in operation S601.

A pre-trained artificial intelligence score model may be used to predict the learning effect. The artificial intelligence score model may predict expected scores that the user will receive after the user solves each problem in the problem candidate list. The learning effect may be determined based on the predicted expected scores. For example, when expected score improvement is high as compared to a current score, it may be determined that the learning effect is high. Further, when the expected score improvement is low as compared to the current score, it may be determined that the learning effect is low.

However, the determination of the learning effect on the basis of the expected scores is one example. According to the embodiment, the learning effect may be determined using various artificial intelligence prediction results related to problem solving in addition to the expected scores. For example, at least one of a time required for solving the problems, a percentage of correct answers for problems, and a weak problem type may be used.

In operation S605, the learning problem recommendation system 50 checks a preset set value for the learning effect.

In operation S607, the learning problem recommendation system 50 may compare whether the learning effect is greater than the preset set value.

As a result of the comparison in operation S607, when the learning effect is greater than the set value, the corresponding problem candidate list may be firstly determined as a problem candidate list to be recommended to the user.

As the result of the comparison in operation S607, when the learning effect is greater than the set value, operation S609 may be performed.

Conversely, as the result of the comparison in operation S607, when the learning effect is smaller than the set value, it is possible to return to operation S601 again to determine the problem candidate list to be recommended to the user, and operations S603 to S607 may be performed again.

In operation S609, the learning problem recommendation system 50 may collect the problem candidate list showing the learning effect greater than the set value and predict a probability distribution of the expected scores that the user will receive after the user solves the collected problem candidate lists.

In operation S611, the learning problem recommendation system 50 may determine the problem candidate list having the extracted value, which is closest to the reference value, among one or more extracted values extracted from the graph of the predicted probability distribution of the expected scores as a recommended problem list.

Thereafter, in operation S613, the learning problem recommendation system 50 may provide the recommended problem list to the user. Specifically, the learning problem recommendation system 50 may provide the recommended problem list to the user through the user terminal 100, and when the user inputs a response to each problem in the recommended problem list through the user terminal 100, the learning problem recommendation system 50 may receive results obtained by the user solving the problems from the user terminal 100.

The learning problem recommendation system 50 may generate evaluation information about the user on the basis of the results obtained by the user solving the problems. Since the users solve the problems with a uniform probability distribution of expected scores, it is possible to evaluate abilities of the plurality of users even when the users solve different customized problem sets.

When compared to the example of FIG. 5, in the example of FIG. 6, the problem candidate list is first determined based on the learning effect and then the recommended problem list is determined based on the probability distribution of the expected scores. As a result, it can be seen that, in the example of FIG. 5, the learning effect is relatively more focused on, whereas, in the example of FIG. 6, the similarity of the probability distribution of the expected scores is more focused on. Therefore, the recommended problem list may be determined selectively or redundantly according to the purpose of use, a usage environment, a test type, and a user pool.

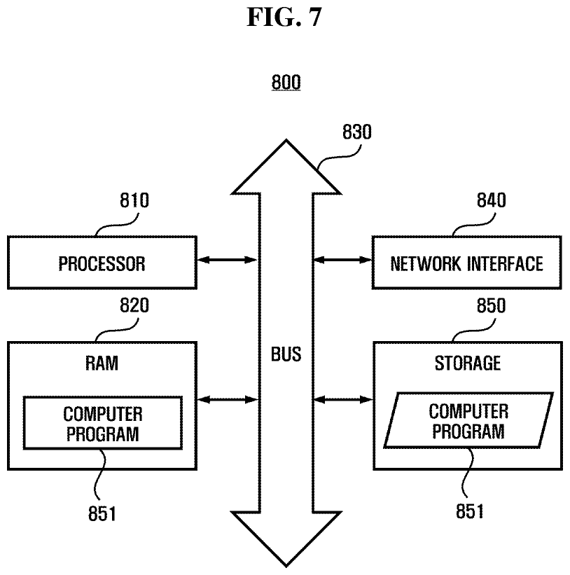

As described above, the learning problem recommendation system and the method of operating the same according to the embodiment of the present disclosure have been described with reference to FIGS. 1 to 6. Hereinafter, an exemplary computing device that can be implemented as the learning problem recommendation apparatus 200 according to some embodiments of the present invention will be described with reference to FIG. 7.

Referring to FIG. 7, a computing device 800 may include one or more processors 810, a storage 850 for storing a computer program 851, a memory 820 for loading a computer program 851 executed by the processors 810, a bus 830, and a network interface 840. However, in FIG. 7, only components related to the embodiments of the present disclosure are shown. Therefore, those skilled in the art to which the present disclosure pertains may know that other general-purpose components other than the components shown in FIG. 7 may be further included.

The processor 810 controls an overall operation of each component of the computing device 800. The processor 810 may include a central processing unit (CPU), a microprocessor unit (MPU), a micro controller unit (MCU), a graphics processing unit (GPU), or any type of processor well known in the art. Further, the processor 810 may perform an operation on at least one computer program for executing the method of operating the learning problem recommendation system according to the embodiments of the present disclosure. The computing device 800 may include one or more processors.

The memory 820 stores data for supporting various functions of the computing device 800. The memory 820 stores at least one of a plurality of computer programs (e.g., application, application program, and application software) driven in the computing device 800, data, instructions, and information for the operation of the computing device 800. At least some of the computer programs may be downloaded from an external device (not shown). Further, at least some of the computer programs may be present on the computing device 800 from a time of being released for basic functions (e.g., message reception and message transmission) of the computing device 800. Meanwhile, the memory 820 may load one or more computer programs 851 from the storage 850 in order to perform the method of operating the learning problem recommendation system according to the embodiments of the present disclosure. In FIG. 7, a random access memory (RAM) is shown as an example of the memory 820.

The bus 830 provides a communication function between the components of the computing device 800. The bus 830 may be implemented using various types of buses such as an address bus, a data bus, a control bus, and the like.

The network interface 840 supports wired/wireless Internet communication of the computing device 800. Further, the network interface 840 may support various communication methods in addition to the Internet communication. To this end, the network interface 840 may include a communication module well known in the art.

The storage 850 may non-temporarily store one or more computer programs 851. The storage 850 may include a non-volatile memory, such as a read only memory (ROM), an erasable programmable ROM (EPROM), an electrically erasable programmable ROM (EEPROM), a flash memory, or the like, a hard disk, a removable disk, or any type of computer-readable recording medium well known in the art to which the present disclosure pertains.

As described above, the exemplary computing device that may be implemented as the learning problem recommendation apparatus 200 according to some embodiments of the present disclosure has been described with reference to FIG. 7. The computing device shown in FIG. 7 may not only be implemented as the learning problem recommendation apparatus 200 according to some embodiments of the present disclosure but may also be implemented as the user terminal 100 according to some embodiments of the present disclosure. In this case, the computing device 800 may further include an input unit and an output unit in addition to the components shown in FIG. 7.

The input unit may include a camera for receiving an image signal, a microphone for receiving an audio signal, and a user input unit for receiving information from a user. The user input unit may include at least one of a touch key and a mechanical key. Image data collected through the camera or audio signals collected through the microphone may be analyzed and may be processed as control commands of the user.

The output unit is for visually, auditorily, or tactilely outputting command processing results and may include a display unit, an optical output unit, a speaker, a haptic output unit, and an optical output unit.

Meanwhile, the components constituting the user terminal 100 or the learning problem recommendation apparatus 200 may be implemented as modules.

The modules refer to software components or hardware components such as a field programmable gate array (FPGA) or an application specific integrated circuit (ASIC) and perform certain roles. However, the module is not meant to be limited to software or hardware. The module may be configured to reside on an addressable storage medium or may be configured to execute one or more processors. Therefore, as an example, the modules include components such as software components, object-oriented software components, class components, and task components, and include processes, functions, properties, procedures, subroutines, segments of program code, drivers, firmware, microcode, circuitry, data, databases, data structures, tables, arrays, and variables. Functions provided by the components and the modules may be combined into a smaller number of components and modules or may be further divided into additional components and modules.

According to the present disclosure, forms of a probability distribution of expected scores for a problem list to be provided to each of users are unified according to a predetermined criterion and then problems to be recommended to each user are determined, and thus recommended problems that are able to ensure objectivity and fairness can be determined when evaluating each user's ability.

Further, according to the present disclosure, forms of a probability distribution of expected scores are unified so that improvement of the score after learning relative to current ability of the user is made proportional to the effort that the user has put into the learning, and thus recommended problems that are able to inspire the user's learning motivation and improve the fairness of learning can be determined.

Effects of the present disclosure are not limited to the above-described effects, and other effects that are not described may be clearly understood by those skilled in the art from the above detailed description.

Meanwhile, the embodiments of the present disclosure disclosed in this specification and drawings are only examples to aid understanding of the present disclosure and the present disclosure is not limited thereto. It is clear to those skilled in the art that various modifications based on the technological scope of the present disclosure in addition to the embodiments disclosed herein can be made. For example, each component specifically shown in the embodiments may be modified and embodied. In addition, it should be understood that differences related to these modifications and applications are within the scope of the present disclosure as defined in the appended claims.

What is claimed is:

1. A learning problem recommendation system for recommending problems through unification of forms of a score probability distribution, the learning problem recommendation system comprising:
a problem candidate list generation unit configured to generate a first problem candidate list to be recommended to a user by combining a preset number of problems among problems stored in a problem database;
a score distribution determination unit configured to predict a probability distribution of expected scores that the user will receive after the user solves the problems included in the first problem candidate list and to determine a second problem candidate list on the basis of a result of comparing an extracted value extracted from a graph of the probability distribution of the expected scores to a preset reference value; and
a learning effect determination unit configured to predict a learning effect that the user will have after the user solves the problems included in the first problem candidate list and to determine a third problem candidate list on the basis of the learning effect,
wherein a recommended problem list to be recommended to the user is determined by filtering the first problem candidate list, the second problem candidate list, and the third problem candidate list according to a predetermined order.

2. The learning problem recommendation system of claim 1, further comprising an evaluation information generation unit configured to generate evaluation information of the user on the basis of a result obtained by solving the problems included in the recommended problem list,
wherein the evaluation information is information expressing ability of the user as a numerical value or grade that is allowed to be compared to that of another user.

3. The learning problem recommendation system of claim 1, wherein, when the extracted value is greater than the preset reference value, the score distribution determination unit determines that the probability distribution of the expected scores is similar to a probability distribution of expected scores of other users and causes the problems having the extracted value among the problems included in the first problem candidate list to be included in the second problem candidate list.

4. The learning problem recommendation system of claim 1, wherein, when the extracted value is smaller than the preset reference value, the score distribution determination unit determines that the probability distribution of the expected scores is not similar to a probability distribution of expected scores of other users and causes the problems having the extracted value among the problems included in the first problem candidate list not to be included in the second problem candidate list.

5. The learning problem recommendation system of claim 1, wherein:
the score distribution determination unit first determines the second problem candidate list by filtering the first problem candidate list so that the probability distribution of the expected scores has a probability distribution that meets a preset criterion; and
the learning effect determination unit determines the third problem candidate list by filtering the first determined second problem candidate list according to the learning effect and determines that the third problem candidate list obtained by the filtering is the recommended problem list.

6. The learning problem recommendation system of claim 1, wherein:
the learning effect determination unit first determines the third problem candidate list by filtering the first problem candidate list according to the learning effect; and
the score distribution determination unit determines the second problem candidate list by filtering the first determined third problem candidate list so that the probability distribution of the expected scores has a probability distribution that meets a preset criterion, and determines that the second problem candidate list obtained by the filtering is the recommended problem list.

7. The learning problem recommendation system of claim 1, wherein:
the learning effect is determined by comparing the expected scores that the user will receive after the user solves the problems included in the first problem candidate list to current scores of the user;
when improvement of the expected scores is high as compared to the current scores, it is determined that the learning effect is high; and
when the improvement of the expected scores is low as compared to the current scores, it is determined that the learning effect is low.

8. The learning problem recommendation system of claim 7, wherein:
the learning effect is determined based on an artificial intelligence prediction result related to problem solving in addition to the expected scores; and
the artificial intelligence prediction result includes at least one of a time required for solving the problems, a percentage of correct answers for problems, and a weak problem type.

9. A method of operating a learning problem recommendation system for recommending problems through unification of forms of a score probability distribution, the method comprising:
generating a first problem candidate list to be recommended to a user by combining a preset number of problems among problems stored in a problem database;
predicting a probability distribution of expected scores that the user will receive after the user solves the problems included in the first problem candidate list and determining a second problem candidate list on the basis of a result of comparing an extracted value extracted from a graph of the probability distribution of the expected scores to a preset reference value; and
predicting a learning effect that the user will have after the user solves the problems included in the first problem candidate list and determining a third problem candidate list on the basis of the learning effect,
wherein a recommended problem list to be recommended to the user is determined by filtering the first problem candidate list, the second problem candidate list, and the third problem candidate list according to a predetermined order.
